(19) United States
(12) Patent Application Publication
(10) Pub. No.: US 2007/0131554 A1
(43) Pub. Date: Jun. 14, 2007

(54) MULTI-SAMPLE MICROFLUIDIC DIELECTROPHORESIS SEPARATING DEVICE AND METHOD THEREOF

(75) Inventors: Tung-Ming Yu, Hsinchu (TW); Cheng-Hsiang Liu, Hsinchu (TW)

Correspondence Address: MICHAEL W. TAYLOR, 255 South Orange Avenue, Suite 1401, P.O. Box 3791, Orlando, FL, 32801-3460, US

(73) Assignee: Industrial Technology Research Institute, Hsinchu (TW)

(21) Appl. No.: 11/550,471

(22) Filed: Oct. 18, 2006

(30) Foreign Application Priority Data
Dec. 9, 2005 (TW) 094143722

(51) Int. Cl. B03C 5/02; B01D 57/02

(52) U.S. Cl. 204/547; 204/643

(57) ABSTRACT

A microfluidic dielecttrophoresis separating device is provided. The microfluidic dielectrophoresis separating device includes a primary passage, at least a secondary passage and at least an electrode assembly. The primary passage has a primary flow containing a plurality of particulates flowing therein. The secondary passage has an input path and an output path and is connected with the primary passage. The electrode assembly generates a dielectrophoresis force to drive a specific one of the particulates into the output path.

### FIELD OF THE INVENTION

The present invention relates to a multi-sample microfluidic dielectrophoresis separating device, in particular to a multi-sample microfluidic dielectrophoresis separating device combining the technologies from both of the dielectrophoresis (DEP) field and the microfluidic field.

### BACKGROUND OF THE INVENTION

Please refer to FIG. 1, which is a schematic view showing a conventional micro flow cytometer. The device diminishes the conventional flow cytometer 1, utilizes the electrokinetic-focusing and the collection via the switch channels 11 at the tail end and employs a buried optical fiber and laser to detect the type of the cell 12. The desired cells 12 are distributed to one of the switch channels at the tail end by the electrokinetic method. The advantage is that the purity of the collection is better. However, the screening speed depends on the speed while detecting each respective cell by the laser and the voltage switching speed, making the mass screening at one time impossible.

Please refer to FIG. 2, which is a schematic view showing a conventional field flow fractionation device. The field flow fractionation device 2 utilizes the DEP force and gravity to position different cells alongside the electrode at different height while the fluid has different flow speeds at different height, these three kinds of forces are used to attain the screening function. The advantages are that more parameters (the DEP force, gravity and flow speed) can be manipulated and the screening of multiple types of cells is possible. Whereas, the control over different cell collections and the screening purity is more difficult when at least two types of cells are screened.

Please refer to FIG. 3, which is a schematic view showing a conventional traveling DEP device. The traveling DEP device 3 utilizes a plurality of electric field signals having different phases to attain the moving function of the particulates 31. In this case, it is unnecessary to drive by the fluid. However, when at least two types of particulates 31 are screened, the screening purity becomes a concern. Meanwhile, it is also short of the collection device.

Please refer to FIG. 4, which is a schematic view showing a conventional positive DEP device. The positive DEP device 4 attracts the cells 12 to be screened onto the electrode 42. Other unnecessary substances are flushed with the fluid. Subsequently, the cells 12 to be screened are released from the electrode 42 for further collection. The advantage is that the purity of the collected cells is higher. However, such mechanism is impossible to simultaneously screen various types of cells 12.

Based on the above, in order to overcome the drawbacks in the prior art, the present invention provides an improved multi-sample microfluidic dielectrophoresis separating device and the method thereof.

### SUMMARY OF THE INVENTION

In accordance with a first aspect of the present invention, a microfluidic dielectrophoresis separating device is provided. The provided device contains a primary passage for a primary flow containing a plurality of particulates flowing therein; at least a secondary passage having an input path and an output path and connected with the primary passage; and at least an electrode assembly generating at least a dielectrophoresis force to drive at least a specific one of the particulates into the output path.

In accordance with a second aspect of the present invention, a microfluidic dielectrophoresis method for a microfluidic dielectrophoresis separating device having a primary passage, at least a secondary passage having an input path and an output path connected with the primary passage and at least an electrode assembly generating at least a dielectrophoresis force is provided. The provided method contains steps of filling the primary passage with a primary flow containing a plurality of particulates; filling the input path with at least a secondary flow so as to make the secondary flow to flow through the input path, the primary passage and to flow out from the output path; generating the at least a dielectrophoresis force for performing one of selecting and separating operations for at least a specific one of the particulates by the at least an electrode assembly; and extracting the at least a specific one of said plurality of particulates via the output path.

The foregoing and other features and advantages of the present invention will be more clearly understood through the following descriptions with reference to the drawing, wherein:

### BRIEF DESCRIPTION OF THE DRAWINGS

FIG. 1 is a schematic view showing a conventional micro flow cytometer;

FIG. 2 is a schematic view showing a conventional field flow fractionation device;

FIG. 3 is a schematic view showing a conventional traveling DEP device;

FIG. 4 is a schematic view showing a conventional positive DEP device;

FIG. 5 is a schematic view showing a multi-sample microfluidic dielectrophoresis separating device according to a preferred embodiment of the present invention;

FIG. 6 is a schematic view showing a multi-sample microfluidic dielectrophoresis separating device without applying the DEP force according to a preferred embodiment of the present invention; and

FIG. 7 is a schematic view showing a multi-sample microfluidic dielectrophoresis separating device applied with the DEP force according to a preferred embodiment of the present invention.

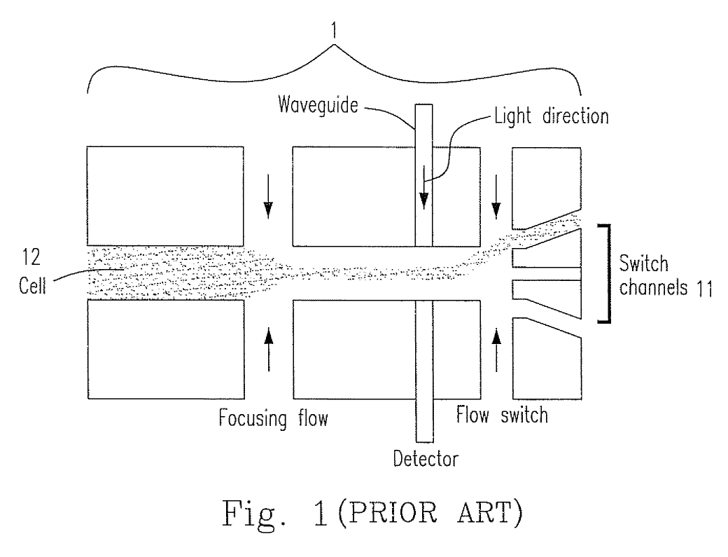

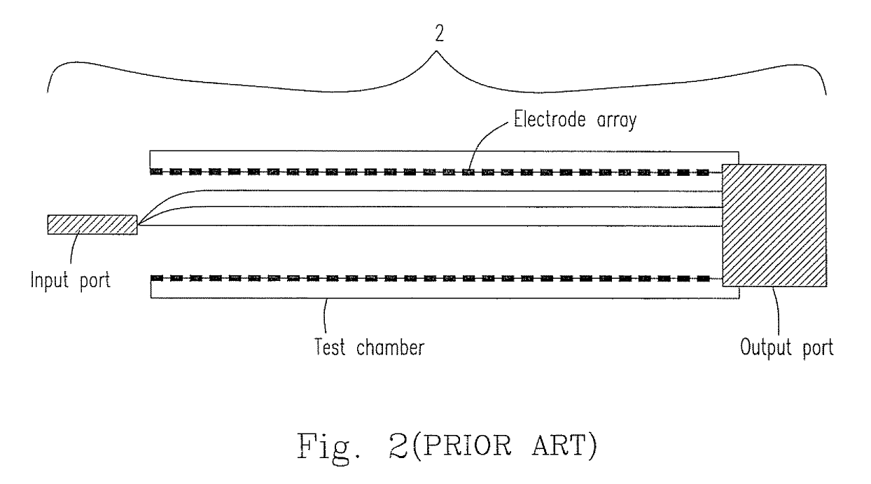

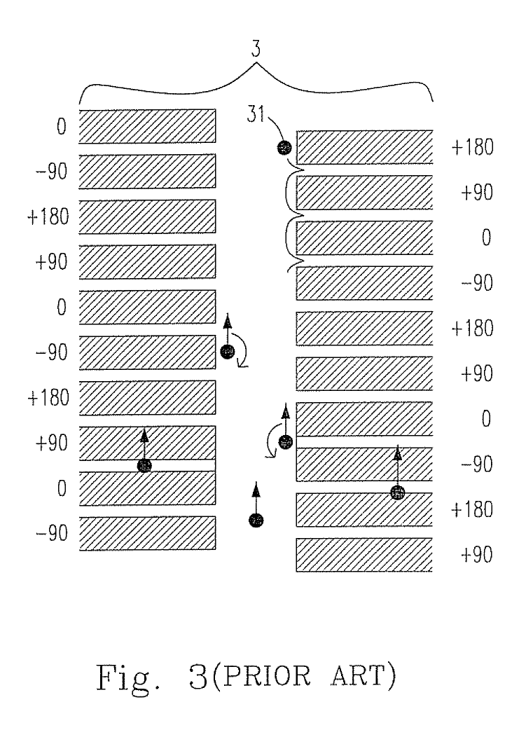

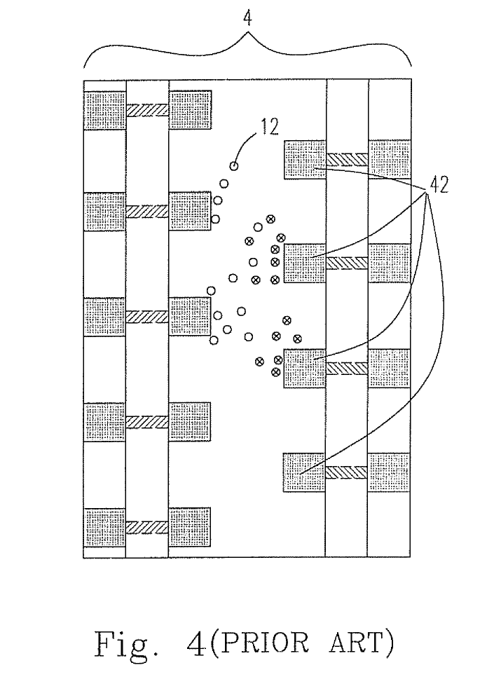

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

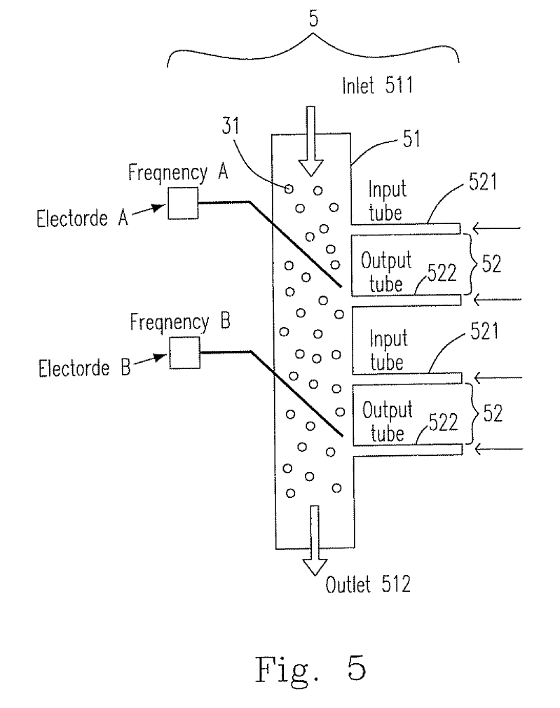

Please refer to FIG. 5, which is a schematic view showing a multi-sample microfluidic dielectrophoresis separating device according to a preferred embodiment of the present invention. The working principle of the multi-sample microfluidic dielectrophoresis separating device 5 is illustrated with reference to FIG. 5. The device 5 is composed of a primary passage 51 and two secondary passages 52 (the number of the secondary passage can be plural and is not limited to two as illustrated in this embodiment), and the secondary passage 52 includes an input path 521 and an output path 522 and the primary passage 51 includes a inlet 511 and a outlet 512. The fluid filled in the input path 521 will flow to the primary passage 51. Due to the laminar flow effect, the fluid filled in the input path 521 won't be mixed with the fluid in the primary passage 51 and will flow out from the output path 522 so as to for a U-shape flow trace (not shown). When the particulates having different dielectric properties or sizes carried in the primary passage flow through the screening area, the DEP force generated from a specific power frequency will affect the particulates 31 with a specific dielectric property, so that the specific particulates 31 penetrates the boundary between the primary passage 51 and the U-shape flow trace to enter the U-shape flow trace area (not shown) and flow out from the output path 522 of the secondary passage 52. The unaffected particulates will follow the primary passage 51 to keep moving forward until the next screening area is met. When encountering a proper DEP force, the particulates can then flow to the second U-shape flow trace (not shown) along the primary passage 51 to be screened out.

Based on the principle, a specific type of cell can be screened by each U-shape flow trace together with a proper DEP force. Multiple types of cells can be screened and collected by repeating such mechanism. As a result of the laminar flow, the flow trace in the primary passage won't be mixed with the U-shape flow trace. Otherwise, cells in the primary passage 51 won't be easy to enter the U-type flow trace unless it is subject to a proper DEP force. As such, during the screening, different cells in the device of the present invention won't be mixed with each other (will be separated/sorted), and thus a better purity is obtained. Moreover, the collection method is relatively easier.

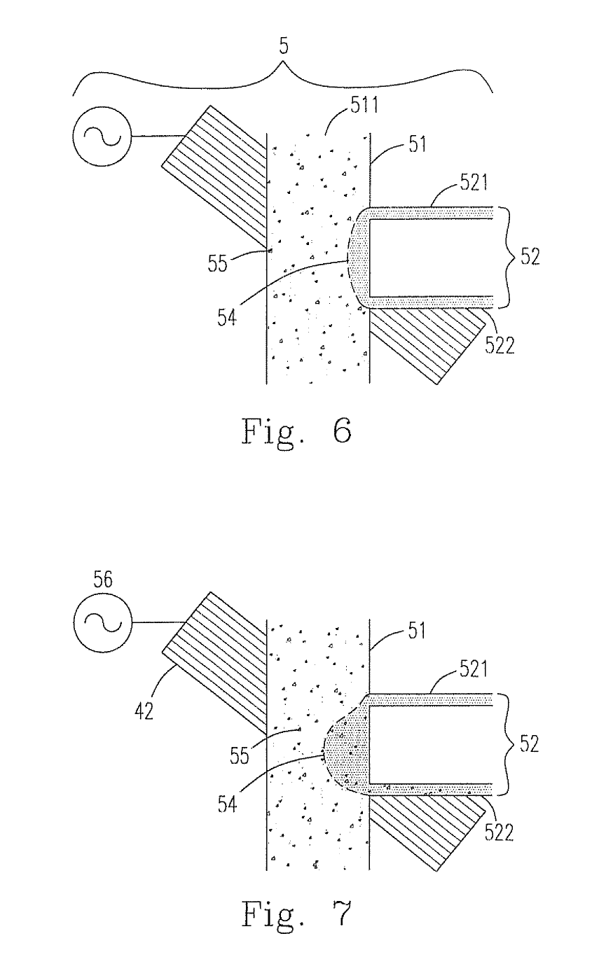

For actually verifying the mentioned principle, please refer to FIG. 6, which is a schematic view showing a multi-sample microfluidic dielectrophoresis separating device without applying the DEP force according to a preferred embodiment of the present invention. The experiment utilizes a multi-sample microfluidic dielectrophoresis separating device 5, which includes a primary passage 51 and two secondary passages 52 (only one secondary passage is shown). The secondary passage is composed of an input path 521 and an output path 522. To facilitate the observation of the experiment, a transparent deionized water is filled in the entry 511 of the primary passage 51, and a deionized water dyed in yellow is injected into the secondary passage 52 and flows through the input path 521 of the secondary passage 52, the primary passage 51 and the output path 522 to form a clear U-shape flow trace 54 (the place bordered with the primary passage 51 and indicated by the dash line). Except the portion where the U-shape flow trace 54 flows through, the primary passage 51 still has the transparent deionized water flowing therein Then the 10 μm latex beads 55 are added to the deionized water in the primary passage 51. A syringe pump (not shown) is further utilized to push the deionized water at a speed of 4 μl/min. The latex beads 55 in the primary passage 51 are not mixed with the latex beads 55 in the yellow U-shape flow trace 54, and they flow independently along their respective flow traces,

Please refer to FIG. 7, which is a schematic view showing a multi-sample microfluidic dielectrophoresis separating device applied with the DEP force according to a preferred embodiment of the present invention. To succeed the mentioned interaction in FIG. 6, the AC power 56 of 200 kHz and 20 Vpp is applied to the electrode 42 to generate a DEP force. As the electrode 42 is disposed to stride over the primary passage 51 and the yellow U-shape flow trace 54, the latex beads 55 in the primary passage 51 can penetrate the boundary of the primary passage 51 and the yellow U-shape flow trace 54 by means of the DEP force, so as to enter the yellow U-shape flow trace 54 and flow out from the output path 522 of the secondary, passage 52 along the yellow U-shape flow trace 54 for collection.

In sum, the present invention provides a design using the laminar flow characteristic of the fluid in the tiny tube (in the microchannel) so that the fluids with different flow traces are uneasy to be mixed with each other. In contrast to the prior ail, the present invention results in the benefits in screening and collecting particulates and achieves a multi-sample microfluidic dielectrophoresis separating device having a simple structure capable of simultaneously fulfilling good screening purity, easy collection, mass screening and multi-sample screening to overcome the drawback of the prior art, making the present invention innovative, progressive and practical.

In accordance with the mentioned descriptions with respect to the present invention, a microfluidic dielectrophoresis separating device is provided and the mentioned descriptions is summarized as follows

Preferably, a secondary flow flows through the input path, the primary passage and the output path for selecting and separating one of the plurality of particulates.

Preferably, the primary flow flows into and out the primary passage through the inlet and the outlet.

Preferably, a flow trace is formed by filling the secondary flow into the input path to flow through a part of the primary passage and the output path.

Preferably, the primary passage and the secondary passage are driven by a primary drive pump and a secondary drive pump connected therewith respectively so as to control a first flow speed of the primary flow in the primary passage and a second flow speed of the secondary flow in the secondary passage.

Preferably, the secondary flow is independent of the primary flow due to a laminar flow effect.

Preferably, the at least an electrode assembly adjusts at least an AC current parameter determined by one selected from a group consisting of all amplitude, a frequency and a phase to generate the at least a dielectrophoresis force for performing one of selecting and separating operations for the at least a specific one of the particulates.

In accordance with the mentioned descriptions with respect to the present invention, a microfluidic dielectrophoresis method for a microfluidic dielectrophoresis separating device is provided and the mentioned descriptions is summarized as follows.

Preferably, the method further contains a step of adjusting a parameter of the at least an electrode assembly for generating the at least a dielectrophoresis force where the parameter is one selected from a group consisting of an amplitude, a frequency and a phase.

Preferably, the at least a secondary flow sequentially flows through the input path, the primary passage and the output path to form at least a flow trace.

Preferably, the secondary flow is independent of the primary flow.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A microfluidic dielectrophoresis separating device, comprising:
a primary passage for a primary flow containing a plurality of particulates flowing therein;
at least a secondary passage having an input path and an output path and connected with said primary passage; and
at least an electrode assembly generating at least a dielectrophoresis force to drive at least a specific one of said plurality of particulates into said output path of said secondary passage.

2. The microfluidic dielectrophoresis separating device of claim 1, wherein a secondary flow flows through said input path, said primary passage and said output path for selecting and separating one of said plurality of particulates.

3. The microfluidic dielectrophoresis separating device of claim 2, wherein said primary flow flows into and out said primary passage through a inlet and a outlet.

4. The microfluidic dielectrophoresis separating device of claim 1, wherein a flow trace is formed by filling said secondary flow into said input path to flow through a part of said primary passage and said output path.

5. The microfluidic dielectrophoresis separating device of claim 4, wherein said primary passage and said secondary passage are driven by a primary chive pump arid a secondary drive pump connected therewith respectively so as to control a first flow speed of said primary flow in said primary passage and a second flow speed of said secondary flow in said secondary passage.

6. The microfluidic dielectrophoresis separating device of claim 4, wherein said secondary flow is independent of said primary flow due to a laminar flow effect.

7. The microfluidic dielectrophoresis separating device of claim 1, wherein said at least an electrode assembly adjusts at least an AC current parameter determined by one selected from a group consisting of an amplitude, a frequency and a phase to generate said at least a dielectrophoresis force for performing one of selecting and separating operations for said at least a specific one of said plurality of particulates.

8. A microfluidic dielectrophoresis method for a microfluidic dielectrophoresis separating device having a primary passage, at least a secondary passage having an input path and an output path connected with said primary passage and at least an electrode assembly generating at least a dielectrophoresis force, comprising steps of:
filling said primary passage with a primary flow containing a plurality of particulates;
filling said input path with at least a secondary flow so as to make said secondary flow to flow through said input path, said primary passage and to flow out from said output path;
generating said at least a dielectrophoresis force for performing one of selecting and separating operations for at least a specific one of said plurality of particulates by said at least an electrode assembly; and
extracting said at least a specific one of said plurality of particulates via said output path.

9. The method of claim 8, further comprising a step of adjusting a parameter of said at least an electrode assembly for generating said at least a dielectrophoresis force where said parameter is one selected from a group consisting of an amplitude, a frequency and a phase.

10. The method of claim 8, wherein said at least a secondary flow sequentially flows through said input path, said primary passage and said output path to for at least a flow trace.

11. The method of claim 10, wherein said secondary flow is independent of primary flow.
